(19) United States
(12) Patent Application Publication
(10) Pub. No.: US 2022/0153328 A1
(43) Pub. Date: May 19, 2022

(54) Multi-Level Delivery System and Associated Apparatus

(71) Applicant: URBAN626, LLC, Pasadena, CA (US)

(72) Inventors: Sven Etzelsberger, Pasadena, CA (US); Grant Delgatty, Pasadena, CA (US)

(73) Assignee: Urban Electric Co., Pasadena, CA (US)

(21) Appl. No.: 17/593,933

(22) PCT Filed: Apr. 2, 2020
(86) PCT No.: PCT/US20/26447

§ 371 Date: Sep. 28, 2021

Related U.S. Application Data
(60) Provisional application No. 62/828,232, filed on Apr. 2, 2019.
(60) Provisional application No. 62/972,525, filed on Feb. 10, 2020.
(60) Provisional application No. 62/981,461, filed on Feb. 25, 2020.
(60) Provisional application No. 62/975,668, filed on Feb. 12, 2020.

(51) Int. Cl. B62B 3/02; A47B 31/04

(52) U.S. Cl. CPC B62B 3/025; B62B 2205/02; A47B 31/04

(57) ABSTRACT

Multi-level delivery systems and various apparatus associated therewith are presented. Multi-level delivery systems include a number of integrated, modular and interchangeable compactible elements that may work either alone or in conjunction with other such elements to allow for the deployment of a delivery system having a smaller overall spatial footprint when compared to comparable conventional delivery systems. Apparatus combining to form a delivery system may include one or more of: a compactible container cart, a compactible cart hauler or trailer and a propulsion means. These elements or apparatus may be deployed in any combination, either together as an integrated system or with compatible conventional apparatus. In combination, delivery systems maximize space efficiency, and allow for adaption to any environment and scale.

### CROSS-REFERENCE TO RELATED APPLICATIONS

This application claims priority to U.S. Provisional Patent Application No. 62/828,232, filed Apr. 2, 2019; U.S. Provisional Patent Application No. 62/972,525, filed Feb. 10, 2020; U.S. Provisional Patent Application No. 62/981,461, filed Feb. 25, 2020; and U.S. Provisional Patent Application No. 62/975,668, filed Feb. 12, 2020. The disclosures of each of the listed provisional patent applications is incorporated herein by reference.

### FIELD OF THE INVENTION

The present invention relates to a multi-level delivery system, and more particularly to a multi-level delivery system incorporating compactible carts, trailers and propulsion devices.

### BACKGROUND OF THE INVENTION

Online shopping is a form of electronic commerce which allows consumers to directly buy goods or services from a seller over the Internet using a web browser. Consumers find a product of interest by visiting the website of the retailer directly or by searching among alternative vendors using a shopping search engine, which displays the same product's availability and pricing at different e-retailers. As of 2020, customers can shop online using a range of different computers and devices, including desktop computers, laptops, tablet computers, smartphones, and smart speakers.

The popularity of online shopping continues to erode sales of conventional retailers. For example, Best Buy, the largest retailer of electronics in the U.S. in August 2014 reported its tenth consecutive quarterly dip in sales, citing an increasing shift by consumers to online shopping. Meanwhile, as of May 2018, a survey found two-thirds of Americans had bought something from Amazon (92% of those who had bought anything online), with 40% of online shoppers buying something from Amazon at least once a month. Moreover, the expansion of online shopping is a worldwide phenomenon. There were 242 million people shopping online in China in 2012.

One major issue to the continued expansion of online retail is a solution to the logistics of the delivery of physical products, particularly in crowded metropolitan areas which are not well-suited to last mile shipping solutions involving large trucks and warehouse infrastructure.

### SUMMARY OF THE INVENTION

Embodiments are directed multi-level delivery systems and multi-level delivery systems incorporating compactible carts, trailers and propulsion devices.

Many embodiments are directed to compactible carts including:
a support structure comprising a pair of longitudinal sidewall elements disposed parallel to each other and a pair of latitudinal end wall elements disposed parallel to each other, wherein the sidewall and end wall elements are pivotably interconnected at each end to each other such that said sidewall and end wall elements may be rotated between a first wall position where the sidewalls and end walls are disposed orthogonal to each other forming an internal volume and a second wall position where the sidewalls and end walls are disposed parallel to each other;
at least a top platform element pivotably interconnected to one of either the sidewall or end wall elements at an upper end thereof, and a bottom platform element pivotably interconnected to one of either the sidewall or the end wall elements at a lower end thereof, such that said internal platform elements may be rotated between a first platform position where said internal platform elements are disposed parallel to the side and end walls and a second platform position where said internal platform elements are disposed perpendicular to the side and end walls; and
a plurality of wheels disposed below the bottom platform, wherein at least one wheel is disposed at each of the corners of the cart;
wherein the elements of the cart are configured such that when at least one of the top or bottom platform elements are disposed in the second platform position the sidewall and end wall elements are prevented from pivoting.

Still many embodiments include at least one internal platform element pivotably interconnected to one of either the sidewall or end wall elements between the upper and lower ends thereof.

In yet many embodiments each of at least the internal and bottom platform elements are formed of two platform elements each pivotably interconnected to opposing sidewall or end wall elements.

In still yet many embodiments each of the sidewalls and end walls are open such that the internal volume is open.

In still yet many embodiments each of the sidewalls and end walls are solid to enclose the internal volume.

[symbol]

6. The compactible cart of claim 5, wherein the at least one of longitudinal sidewall element is pivotably connected to an upper portion of the support structure such that the sidewall may be rotated relative to the support structure providing access to the internal volume.

In still yet many embodiments the at least one pivotably connect longitudinal sidewall element is formed of two pivotably interconnected longitudinal sidewall portions.

Still yet many embodiments include at least one latch configured to secure the at least one pivotably connected longitudinal sidewall element from rotation relative to the support structure.

In still yet many embodiments the top platform and pivotably connected longitudinal sidewall are hinged together such that only one may be rotated relative to the support structure at a time.

Still yet many embodiments include at least one latch configured to secure the top platform from rotation relative to the support structure.

Some embodiments are directed to compactible haulers including:
a frame supporting a platform, wherein said frame and platform are formed of at least front and rear portions pivotably interconnected along a longitudinal axis thereof such that said at least two portions may be rotated between a first position where the portions are disposed in-line with each other and a second position where the portions are disposed in adjacent parallel planes; and
at least two sets of wheels, wherein at least one set of wheels is disposed on a front portion and wherein at least one set of wheels is disposed on a rear portion, and wherein when the portions are disposed in the second position the sets of wheels overlap;
wherein the rear wheels are pivotable relative to the frame and platform such that in a first position the rear and portions are disposed at the same height, and wherein in a second position the rear portion is dispose at a height lower than the front portion.

In yet some embodiments a single wheel is disposed on the front portion and a set of two wheels are disposed on the rear portion.

In still some embodiments the platform further comprises a center open section configured such that the single wheel on the front portion passes at least partially therethrough when disposed in the second position.

Still yet some embodiments include a surge braking mechanism disposed on the front portion.

In still yet many embodiments the surge braking mechanism includes:
at least a first brake support member interconnected with the hauler frame;
at least a second brake support member pivotably interconnected with the first brake support member and configured to be interconnected with a propulsion device at an end distal to the second brake support member;
a pneumatic brake element having a pneumatic cylinder fixedly interconnected to the second brake support member, and a rod having a resilient member disposed thereon, the rod slidingly engaged within the pneumatic cylinder at a first end and fixedly interconnected to the first brake support member;
wherein when the first brake support member is pivoted in the direction of the second brake support member the rod is pushed into the pneumatic cylinder applying the braking mechanism.

Various embodiments are directed to delivery systems including:
a compactible hauler including:
   a frame supporting a platform, wherein said frame and platform are formed of at least front and rear portions pivotably interconnected along a longitudinal axis thereof such that said at least two portions may be rotated between a first position where the portions are disposed in-line with each other and a second position where the portions are disposed in adjacent parallel planes, and
   at least two sets of wheels, wherein at least one set of wheels is disposed on a front portion and wherein at least one set of wheels is disposed on a rear portion, and wherein when the portions are disposed in the second position the sets of wheels overlap,
   wherein the rear wheels are pivotable relative to the frame and platform such that in a first position the rear and portions are disposed at the same height, and wherein in a second position the rear portion is dispose at a height lower than the front portion; and
   wherein the platform is configured to support a compactible cart including:
      a support structure comprising a pair of longitudinal sidewall elements disposed parallel to each other and a pair of latitudinal end wall elements disposed parallel to each other, wherein the sidewall and end wall elements are pivotably interconnected at each end to each other such that said sidewall and end wall elements may be rotated between a first wall position where the sidewalls and end walls are disposed orthogonal to each other forming an internal volume and a second wall position where the sidewalls and end walls are disposed parallel to each other,
      at least a top platform element pivotably interconnected to one of either the sidewall or end wall elements at an upper end thereof, and a bottom platform element pivotably interconnected to one of either the sidewall or the end wall elements at a lower end thereof, such that said internal platform elements may be rotated between a first platform position where said internal platform elements are disposed parallel to the side and end walls and a second platform position where said internal platform elements are disposed perpendicular to the side and end walls, and
      a plurality of wheels disposed below the bottom platform, wherein at least one wheel is disposed at each of the corners of the cart,
      wherein the elements of the cart are configured such that when at least one of the top or bottom platform elements are disposed in the second platform position the sidewall and end wall elements are prevented from pivoting.

Still various embodiments include a propulsion device interconnectable with the compactible hauler.

In yet various embodiments the propulsion device is a compactible electric scooter.

Embodiments are also directed to methods of delivering packages including:
delivering goods to a distribution center;
organizing said goods onto one or more compactible carts including:
   a support structure comprising a pair of longitudinal sidewall elements disposed parallel to each other and a pair of latitudinal end wall elements disposed parallel to each other, wherein the sidewall and end wall elements are pivotably interconnected at each end to each other such that said sidewall and end wall elements may be rotated between a first wall position where the sidewalls and end walls are disposed orthogonal to each other forming an internal volume and a second wall position where the sidewalls and end walls are disposed parallel to each other,
   at least a top platform element pivotably interconnected to one of either the sidewall or end wall elements at an upper end thereof, and a bottom platform element pivotably interconnected to one of either the sidewall or the end wall elements at a lower end thereof, such that said internal platform elements may be rotated between a first platform position where said internal platform elements are disposed parallel to the side and end walls and a second platform position where said internal platform elements are disposed perpendicular to the side and end walls, and
   a plurality of wheels disposed below the bottom platform, wherein at least one wheel is disposed at each of the corners of the cart,
   wherein the elements of the cart are configured such that when at least one of the top or bottom platform elements are disposed in the second platform position the sidewall and end wall elements are prevented from pivoting;
loading said compactible carts onto one or more compactible haulers including:
   a frame supporting a platform, wherein said frame and platform are formed of at least front and rear portions pivotably interconnected along a longitudinal axis thereof such that said at least two portions may be rotated between a first position where the portions are disposed in-line with each other and a second position where the portions are disposed in adjacent parallel planes, and
   at least two sets of wheels, wherein at least one set of wheels is disposed on a front portion and wherein at least one set of wheels is disposed on a rear portion, and wherein when the portions are disposed in the second position the sets of wheels overlap,
   wherein the rear wheels are pivotable relative to the frame and platform such that in a first position the rear and portions are disposed at the same height, and wherein in a second position the rear portion is dispose at a height lower than the front portion; and
interconnecting each compactible hauler with a propulsion system to deliver said goods.

Additional embodiments and features are set forth in part in the description that follows, and in part will become apparent to those skilled in the art upon examination of the specification or may be learned by the practice of the disclosed subject matter. A further understanding of the nature and advantages of the present disclosure may be realized by reference to the remaining portions of the specification and the drawings, which forms a part of this disclosure.

### BRIEF DESCRIPTION OF THE DRAWINGS

These and other features and advantages of the present invention will be better understood by reference to the following detailed description when considered in conjunction with the accompanying data and figures, wherein:

FIG. 1 provides a flowchart of a multilevel delivery system in accordance with embodiments.

FIGS. 2A to 2C provide schematic illustrations of a compactible container in accordance with embodiments.

FIG. 3 provides a schematic of a truck loading scheme in accordance with the prior art.

FIG. 4 provides a schematic of a truck loading scheme in accordance with embodiments.

FIG. 5 provides a schematic of a container loading scheme in accordance with the prior art.

FIG. 6 provides a schematic of a container loading scheme in accordance with embodiments.

FIG. 7 provides a schematic perspective illustration of a compactible container in accordance with embodiments.

FIGS. 8A and 8B provide schematic side view illustrations of a compactible container in an unfolded (8A) and compacted (8B) configuration in accordance with embodiments.

FIG. 9 provides a schematic top perspective view illustration of a compactible container in accordance with embodiments.

FIG. 10 provides a schematic perspective view illustration of a fully enclosed compactible container in accordance with embodiments.

FIGS. 11A and 11B provide schematic perspective illustrations of a compactible container with foldable sidewall in accordance with embodiments.

FIG. 12 provides a schematic perspective illustration of a compactible container with open top platform in accordance with embodiments.

FIGS. 13 and 14 provide close-up schematic illustrations of a hinge mechanism of a compactible container in accordance with embodiments.

FIGS. 15A and 15B provide schematic perspective illustrations of a compactible container with foldable internal platforms in accordance with embodiments.

FIG. 16 provides a schematic of a method of folding a compactible container in accordance with embodiments.

FIGS. 17A to 17C provide schematic top view illustrations of the folding of a compactible container in accordance with embodiments.

FIG. 18 provides a schematic of a number of stacked compactible containers in accordance with embodiments.

FIG. 19 provides a schematic of a hauler staging scheme in accordance with the prior art.

FIG. 20 provides a schematic of a hauler staging scheme in accordance with embodiments.

FIG. 21A provides a schematic top perspective illustration of a compactible hauler in an unfolded configuration in accordance with embodiments.

FIG. 21B provides a schematic top perspective illustration of a compactible hauler in a folded configuration in accordance with embodiments.

FIG. 22 provides a schematic bottom perspective illustration of a compactible hauler in accordance with embodiments.

FIG. 23 provides a schematic side-view illustration of a compactible hauler in a raised configuration in accordance with embodiments.

FIG. 24 provides a schematic side-view illustration of a compactible hauler in a lowered configuration in accordance with embodiments.

FIG. 25 provides a schematic side-view illustration of a loaded compactible hauler in accordance with embodiments.

FIG. 26 provides a schematic top-view illustration of a loaded compactible hauler in accordance with embodiments.

FIG. 27 provides a schematic perspective view illustration of a braking mechanism in accordance with embodiments.

FIGS. 28 and 29 provide schematics of a braking mechanism during operation in accordance with embodiments.

FIG. 30 provides a schematic side-view illustration of a compactible hauler in a raised configuration during loading in accordance with embodiments.

FIG. 31 provides a schematic side-view illustration of a compactible hauler in a lowered configuration during loading in accordance with embodiments.

FIGS. 32 and 33 provide schematic top-view illustrations of loaded compactible haulers connected with propulsion devices in accordance with embodiments.

FIG. 34 provides a schematic illustration of a delivery system incorporating compactible containers, haulers and propulsion systems in accordance with embodiments.

### DETAILED DISCLOSURE

The embodiments of the invention described herein are not intended to be exhaustive or to limit the invention to precise forms disclosed. Rather, the embodiments selected for description have been chosen to enable one skilled in the art to practice the invention.

Turning now to the drawings, a multi-level delivery system and various apparatus associated therewith are presented. In many embodiments a multi-level delivery system includes a number of integrated, modular and interchangeable compactible elements that may work either alone or in conjunction with other such elements to allow for the deployment of a delivery system having a smaller overall spatial footprint when compared to comparable conventional delivery systems. Embodiments of apparatus combining to form a delivery system may include one or more of: a compactible container cart, a compactible cart hauler or trailer and a propulsion means. These elements or apparatus may be deployed in any combination, either together as an integrated system or with compatible conventional apparatus. In combination, a delivery system in accordance with embodiments maximizes space efficiency, and allows for adaption to any environment and scale.

With the rise of online marketplaces delivery, and more particularly delivery in dense population centers presents significant challenges. Specifically, while warehouses outside of metropolitan areas are efficient at holding goods for shipment into the city, the last mile shipping, that is getting the goods from the warehouse to customers in the city center, creates enormous complications. Typically shippers rely on the ability to transport everything from the warehouse directly to customers in trucks. While direct shipping is possible, albeit inefficient and environmentally destructive, in less dense areas, in highly dense cities street parking for large trucks is either insufficient or unavailable. In these highly dense urban corse it is necessary for shippers to develop an infrastructure of distribution centers within the city from which deliveries may be transferred from large trucks to smaller vehicles including in many cases bicycle and cart delivery vehicles.

While such distribution centers and more local delivery means may address the problem of street parking, current solutions are unwieldy and inefficient. Specifically, the requirement for distribution locations in city centers increases costs for shippers. Moreover, existing urban delivery vehicles are large and inflexible, requiring excessive space both during use and when not in use and being stored. Also, many of these delivery vehicles simply were not designed for the use case and so are not sufficiently durable or compatible with the task. Finally, deliveries tend to surge during specific times of the day and year. Current delivery vehicles do not allow for efficient storage during down times meaning that adding delivery capacity is difficult or impossible. Embodiments of the instant disclosure are directed to a multi-level delivery system that is space efficient, flexible and compatible with many different delivery methods.

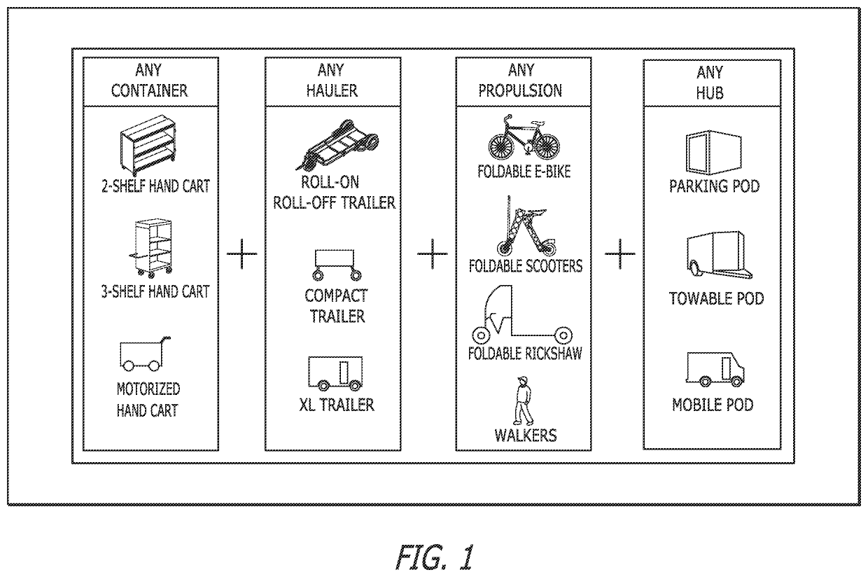

Turning to the figures, many embodiments may include several levels of different apparatus that can be used in conjunction to create an integrate delivery system. As shown in FIG. 1, various such embodiments may include containers, such as motorized or unmotorized carts, hauler or trailers for moving the containers from distribution centers to the customer, and a propulsion device, such as a bike, e-bike, rickshaw, electric scooter, etc. These delivery apparatus may also be combined with a static or movable pod for storing the delivery components when not in use. Although specific embodiments of containers, haulers and propulsion apparatus are set forth in the following sections, it will be understood that more broadly these apparatus when taken in combination according to embodiments allow for compatible elements to be combined in different configurations depending on the specific need.

### Embodiments Implementing Compactible Containers

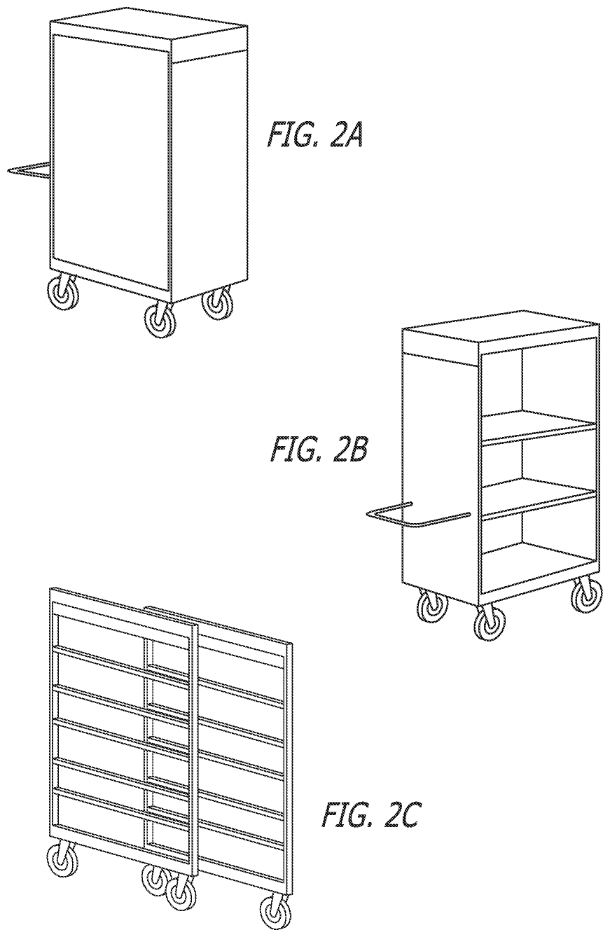

Various embodiments incorporate compactible wheeled cart containers having at least two operational configurations. In many such embodiments the compactible cart has a first unfolded configuration where longitudinal and latitudinal side walls are orthogonal to each other, and where the interior platforms are set in horizontal configurations orthogonal to the planes of the side walls, and at least a second compacted configuration where both the longitudinal and latitudinal side walls are disposed parallel to each other and where the interior platform are folded into a configuration parallel to the planes of the sidewalls, as shown in FIGS. 2A to 2C. In various other embodiments, each level of interior platform is formed of two separate hinged platform elements. In some embodiments each of two edges of the latitudinal walls are pivotably connected to different edges of the longitudinal walls. In various embodiments, at least one of the sidewalls is comprised of two sidewall portions, which are pivotably connected to each other. In many such embodiments one of two sidewall portions is itself pivotably connected to a sidewall support beam configured to span between the two adjacent sidewalls. Some embodiments further comprise a top portion itself pivotable connected along the edge of at least one of the sidewalls.

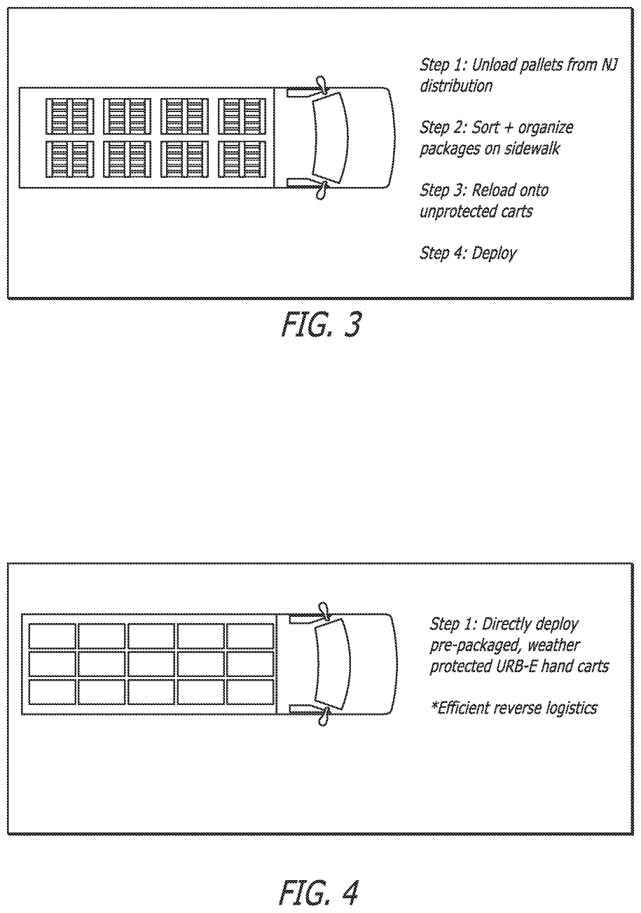

The use of such cart containers addresses a number of specific problems with the current delivery infrastructure. In conventional delivery systems, as shown in FIG. 3, product is delivered from the warehouse to the distribution center on pallets that must be unloaded (often where space is unavailable on a public throughway such as a sidewalk) and then sorted, organized and reloaded onto delivery carts that are then deployed for deliveries. Using an integrated delivery system according to embodiments, deliveries can be organized, sorted and loaded into cart containers at the warehouse and shipped directly to the distribution center in a preloaded configuration, as shown in FIG. 4.

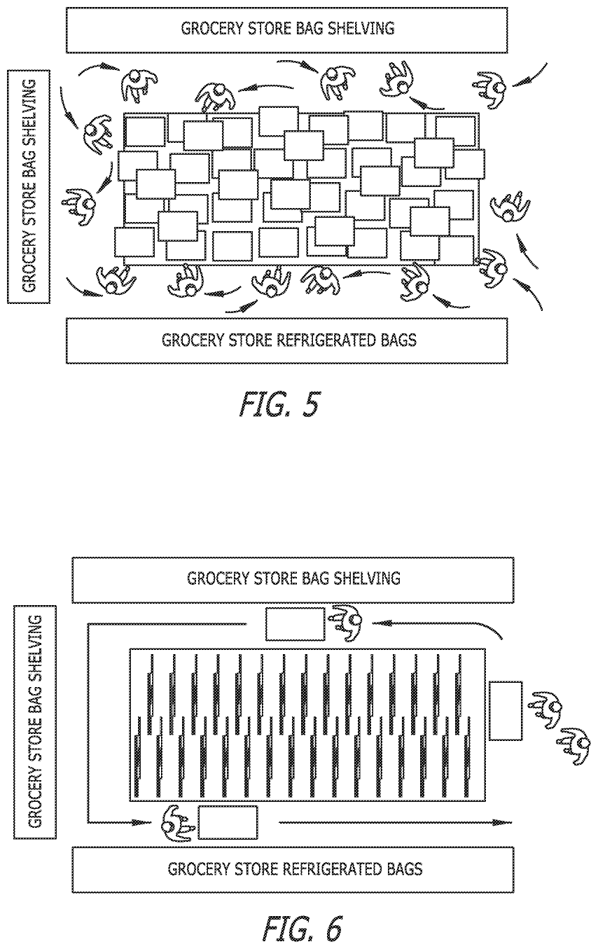

Moreover, even where product is delivered to distribution centers using a conventional pallet system, embodiments allow for the more efficient organization and sorting of such product. Specifically, as shown in FIG. 5, the current method of sorting product at a distribution center is disorganize and cumbersome. Typically, product is placed in shelves about a center open area where the delivery container are stored. Product is then selected from the shelves and inserted into appropriate containers for delivery. Such systems are time consuming and lack an organizing flow, requiring sorters to take many trips back and for between various shelves and the containers. By contrast, embodiments propose a system in which compactible wheeled carts are disposed in a central area, unfolded, and then moved around the shelves of the distribution center in a systematic racetrack manner, as shown in FIG. 6. Such a single direction flow allows for efficient sorting and organization of deliveries within the cart containers according to embodiments.

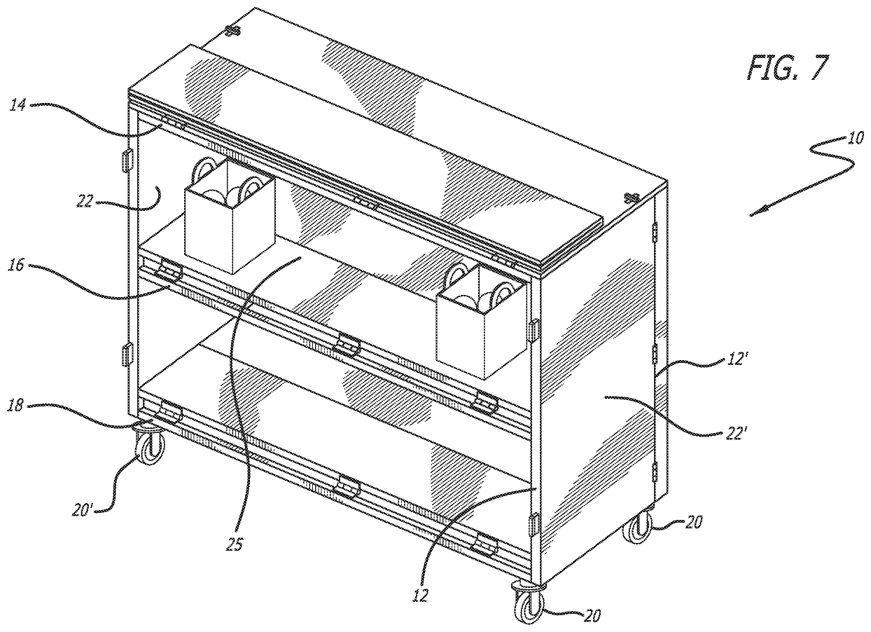

Such a system is only possible provided cart container embodiments, as described and shown in FIGS. 6A to 6C, capable of being compacted such that a central racetrack system may be disposed within the footprint of a distribution center. The construction of such compactible container carts according to embodiments is discussed in greater detail with respect to FIGS. 7 to 17.

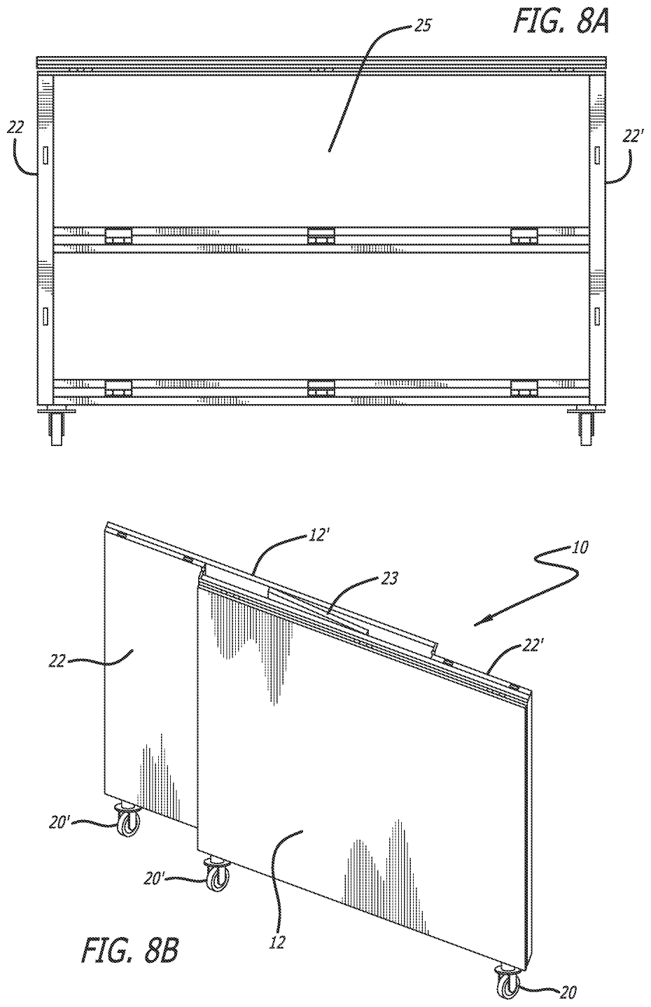

As shown in FIG. 7, in many embodiments the compactible carts (10) are comprised of a pair of side frame structures (12 & 12′) having upper (14), lower (16) and middle (18) elongated supports, and at least two sets of wheels (20 & 20′) disposed along the lower beams of each of the frame structures. In many embodiments, the frame structures are pivotably interconnected to each other at least through a pair of end members (22 & 22′) which themselves may comprise upper, lower and middle supports. (Note, although not shown in FIGS. 7 or 8A, any number of pivotable beams may interconnect the side frame structures between the two end members (22 & 22′). An example of a pivotable middle member (23) is shown, for example, in FIG. 9).

Regardless of the number of beams interconnecting the side frame structures, each beam is pivotably connected at each end to a point on one of the two side frame structures. These pivotable beams are configured such that the frame structures may be configured as pairs of parallel frames (sides 12 & 12′ and ends 22 & 22′) disposed orthogonal to each other to form an interior volume (25) (as shown in FIG. 8A) on which deliveries may be placed, or a series of stacked parallel elements (as shown in FIG. 8B).

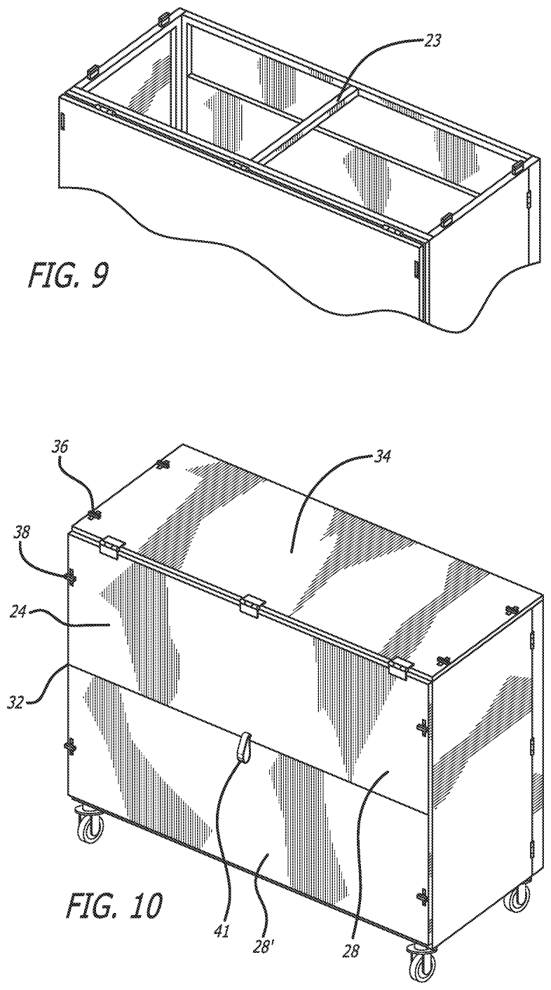

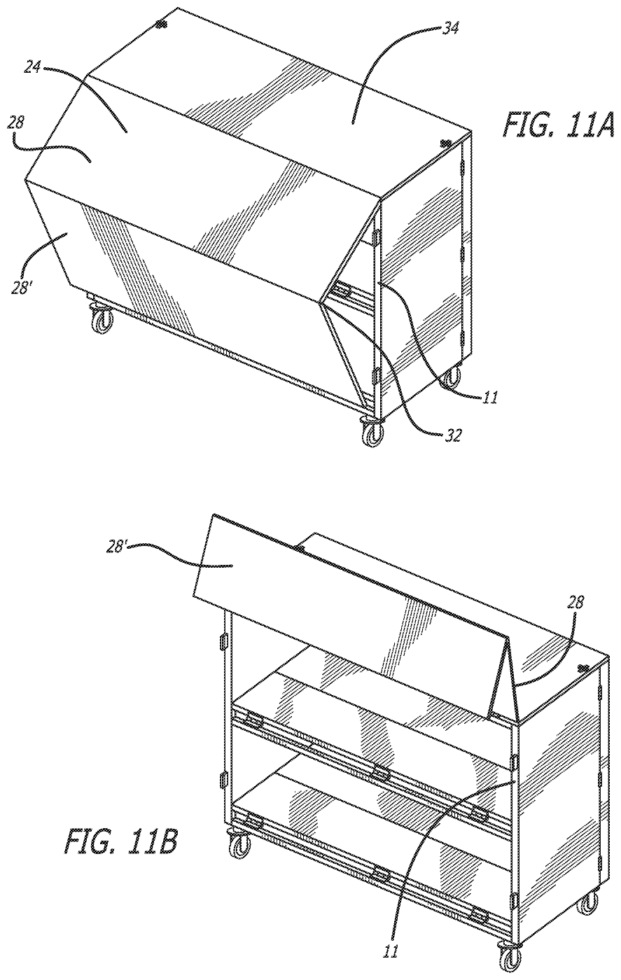

In various embodiments, as shown in the figures, the cart container further may either be open or comprise a series of walls configured to cover the side frame structures (12 & 12′) and end members (22 & 22′) to provide items stored within protection from the elements. Although the various walls may be unitary constructs, it should be understood that any of the walls may be formed of multiple portions of any desired length and height provided the walls cover the interior volume. These multiple portions may also be pivotable relative to each other such that the walls may be moved to expose the interior volume. An exemplary embodiment of such a compactible cart is shown in FIGS. 10 and 11A to 11B. As shown, in some such embodiments the wall (in this example one of the side walls (24)) is formed of upper (28) and lower (28′) portions that are pivotably connected together (30). In embodiments the walls, whether unitary or segmented may in turn be pivotably connected (32) to the frame (11) such that the interior volume may be accessed.

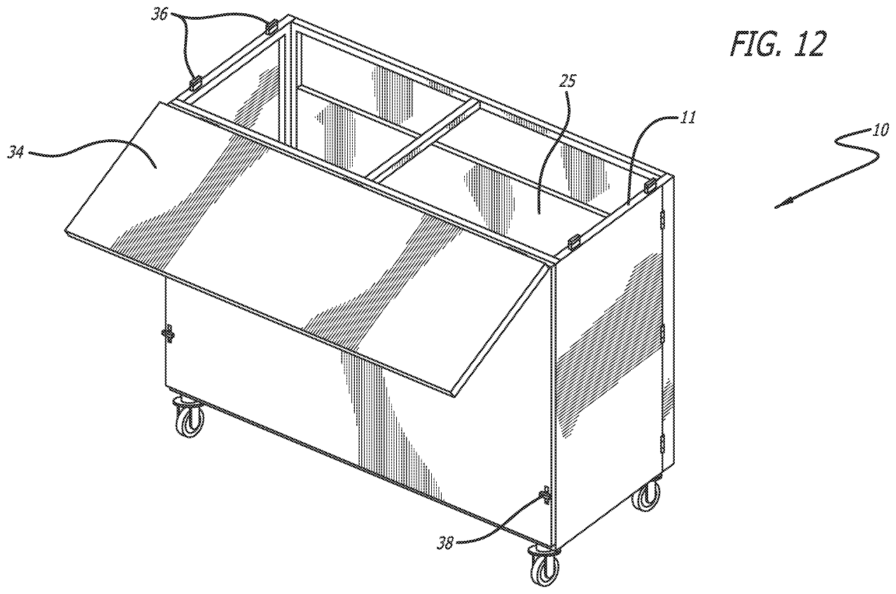

In some such embodiments, more than one or all of the walls may be thus segmented and/or pivotable in relation to the frame of the cart. In various embodiments, as shown in FIG. 12, a top wall (34) of the cart is pivotably connected to the top of the frame (11) such that the interior volume (25) of the cart may be accessed. In many such embodiments, the pivotable walls may be fixed into a closed position (as shown in any of FIGS. 10 to 14) through a series of latches (36) to prevent pivoting of the frame elements relative to each other. Similarly, the other pivotable walls (e.g., sidewall (28/28′)) may be fixed in place through a series of similar latches (38).

Regardless of the specific design of each wall, in many embodiments the walls of the compactible cart are each made of a rigid material and comprise one or more panels having one or more portions. In some embodiments, the sidewall panels may each be configured to span the length of the respective frame. In many such embodiments, when the sidewalls are fully extended (as shown for example in FIG. 10), each of the side wall panels span between their respective frame supports, and each of the foldable panels meet on each side of the care such that the combination of the wall panels completely surround and define the interior of the cart. In many embodiments, for each side or end wall of the cart, one or more panels is pivotably attached at least one of the frame beams and or one of the other walls.

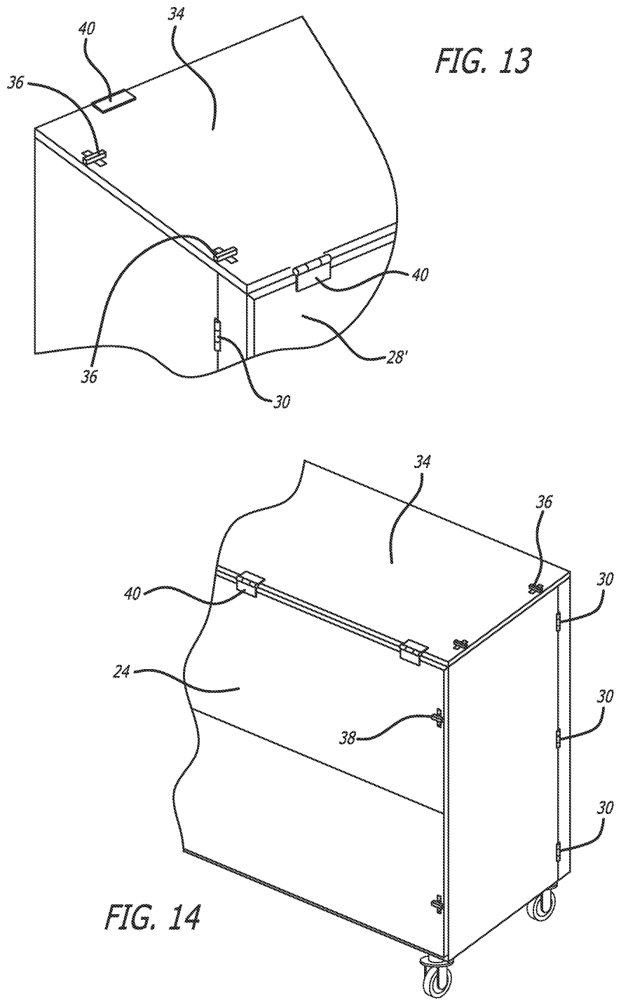

In one embodiment, as shown in FIGS. 13 and 14, the top (34) and at least one of the other side or end walls (e.g., 24) are pivotably attached to each other (40) such that only one of either the top or side are capable of pivoting at the same time. For example, in various embodiments the front sidewall (24) may be pivoted up to expose the inner volume only when the top wall (34) is latched in place. In turn, the top wall (34) is only pivotable when the sidewall (24) is latched into place.

Although the walls are shown as being formed of either one or two panel portions, it should be understood that any number of panels and sections may be used such that the sidewalls are capable of spanning the distance between the front and rear walls, and foldable such that the inner volume may be accessed.

In many embodiments at least one of the walls further comprises at least one handle (41), as shown in FIG. 10) disposed along a portion of a face thereof to assist in opening and closing the wall. In various embodiments, the panels may further comprise cooperative latches (35 & 38) that can be latched when the walls are disposed in an unfolded configuration to ensure the cart is stably fixed in place. In some such embodiments, at least one of the set of latches is disposed along the edges of the wall panels. In various embodiments, the latches may be chosen from the group consisting of hook and loop, buttons, snaps, zippers, etc.

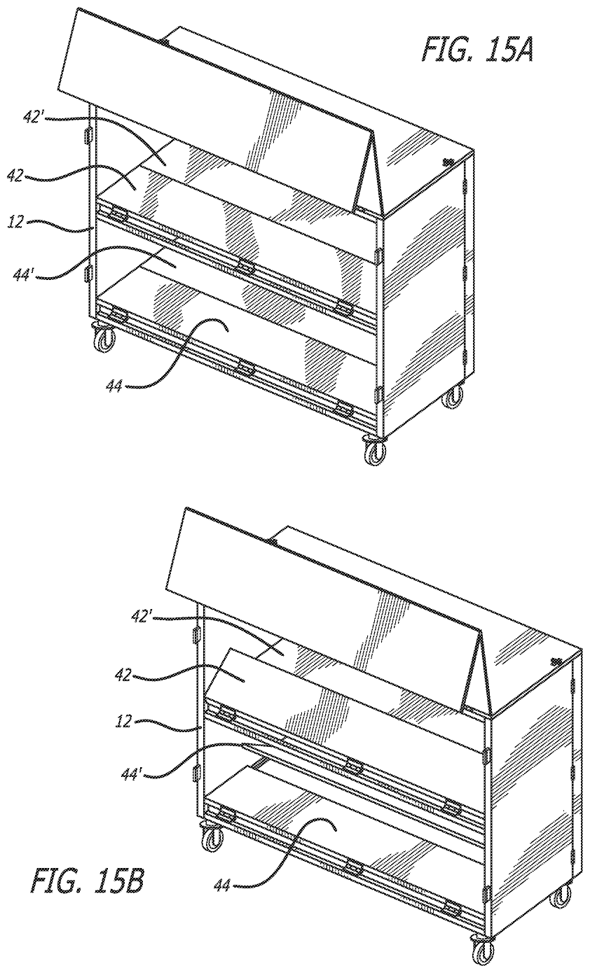

As shown in FIGS. 15A and 15B, in various embodiments the cart comprises a set of interior platforms (42 & 44) that are also pivotably connected to the frames (e.g., 12 & 12′). In many such embodiments the interior platforms (42 & 44) are formed of multiple portions (42′ & 42″ and 44′ & 44″) such that they may be pivoted relative to the walls of the cart to be positioned either parallel to the side walls of the cart or perpendicular to the side walls to form a set of horizontal platforms. In embodiments where pivotable middle members (e.g., 23) are present in the cart, the interior platforms may rest thereon to provide additional stability to the cart in the unfolded configuration. In many embodiments, the interior platforms are pivotable in at least a 90-degree arc outward away from the central point of the cart, thus folding the interior platforms against the sidewalls of the cart, as shown in FIG. 15B. Although two the interior platforms are shown in the figures, it will be understood that any number of interior platforms may be disposed within the inner volume of the cart. In addition, although the interior platforms are shown as pivotably interconnected with the sidewalls of the cart, it will be understood that the platforms may also be interconnected with the end walls.

Although two sets of two wheels are shown in the figures, it will be understood that any number of sets of wheel comprising any number of wheels may be disposed to provide stability to the wagon, and each of the sections of the wagon platform and provide it with the capability to move via rotary motion of the wheel sets. In many such embodiments, the rear and front sets of wheels are offset relative to each other by a sufficient amount to provide stability to the wagon. In some such embodiments, the sets of wheels are disposed proximal to opposite ends of the horizontal platform. In various such embodiments at least one pair of wheels may further comprise a handle mechanically interconnected thereto. In some such embodiments one or both of the sets of wheels are pivotable about an axis perpendicular to the longitudinal axis of the horizontal platform of the wagon, such that the direction of the sets of wheels may be controlled.

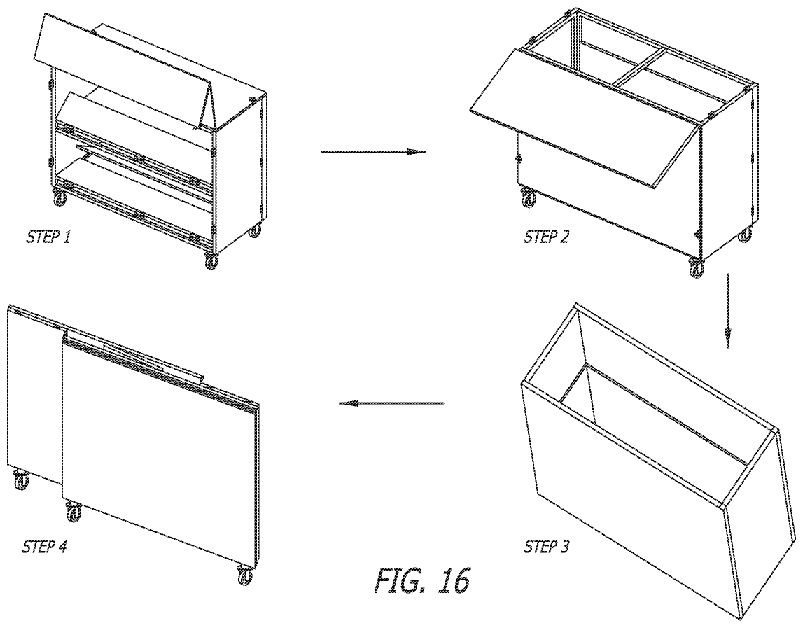

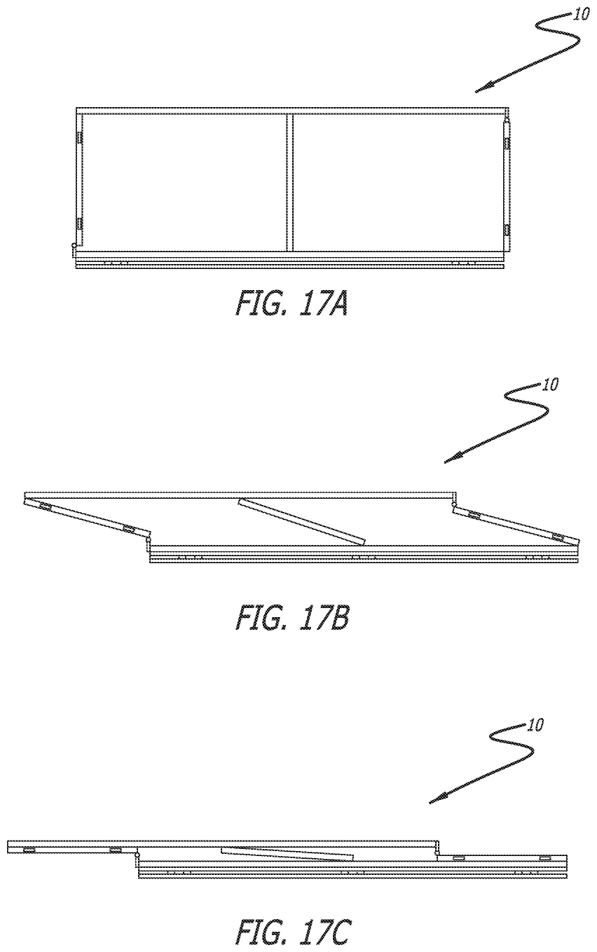

As shown in FIG. 16, in the various embodiments the frames and walls are all hinged or foldable relative to each other such that the frames/wall panels fold flat together and nest such that the frames/panels are all disposed parallel to each other when in a fully compacted configuration. In various embodiments, as shown in Step 1, the cart is readied for compaction by lifting the interior platforms from a disposition orthogonal to the walls (side and end) of the cart to a position parallel to the walls (side and end). In Step 2 the top wall (where present) is folded flat against the outer face of the sidewall. With the various portions of the cart spanning the side frames of the cart removed, as shown in Step 3, the various frames and walls of the cart are pivotable relative to each other such that they may be folded into a series of parallel planes (as shown in Step 4). A series of images showing this folding process from a top view are provided in FIGS. 17A to 17C.

Although not shown in the photos, to prevent the wagon from unfolding uncontrollably a retaining mechanism, such as a lock, clasp, or retaining strap may be incorporated into the cart to secure the frames and walls of the cart from moving relative to each other once locked.

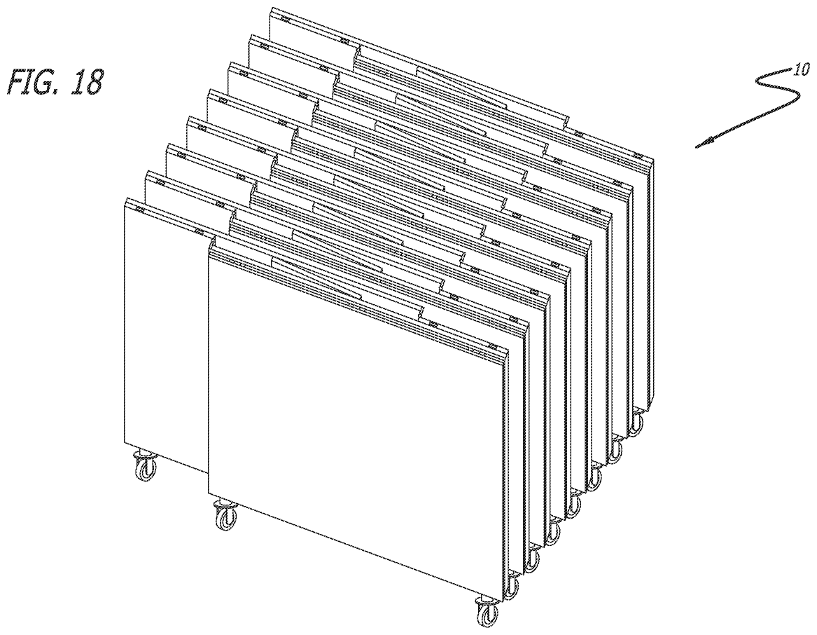

Although many embodiments are described above in reference to FIGS. 7 to 17, other embodiments may also be contemplated. For example, the walls may be detachable such that they can be removed from the sides of the wagon. In various embodiments, as shown, such hard walls may be detachably attached to the wagon via fasteners, such as, for example, snaps, buttons, zippers or hook & latch fasteners. Regardless of the specific construction of the compactible carts, according to embodiments, carts capable of such compaction allow for substantial space saving when stored next to each other, as shown, for example, in FIG. 18. As previously discussed, such stackability has significant operational implications for embodiments of delivery systems.

### Embodiments Implementing Compactible Haulers

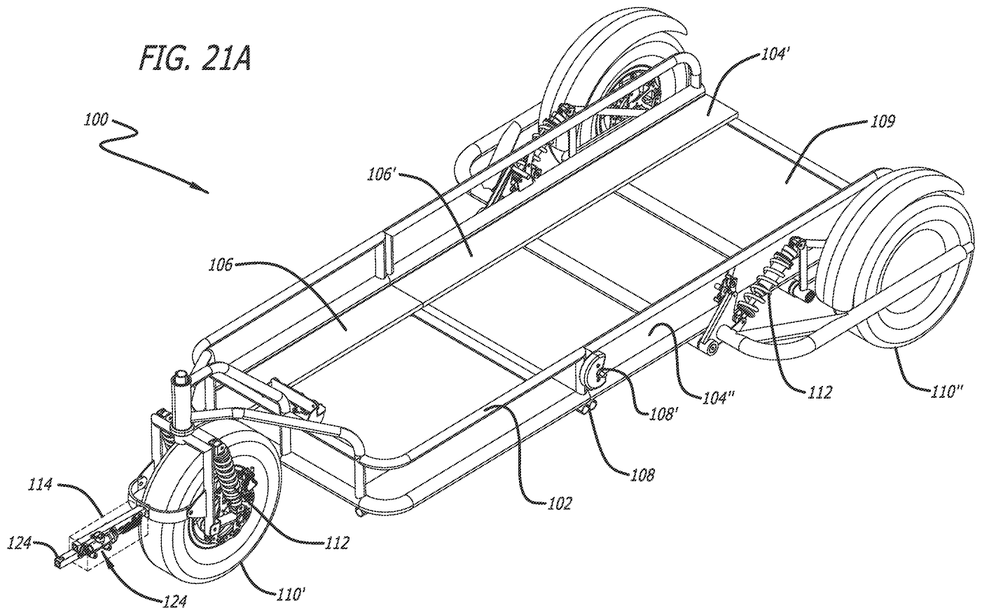

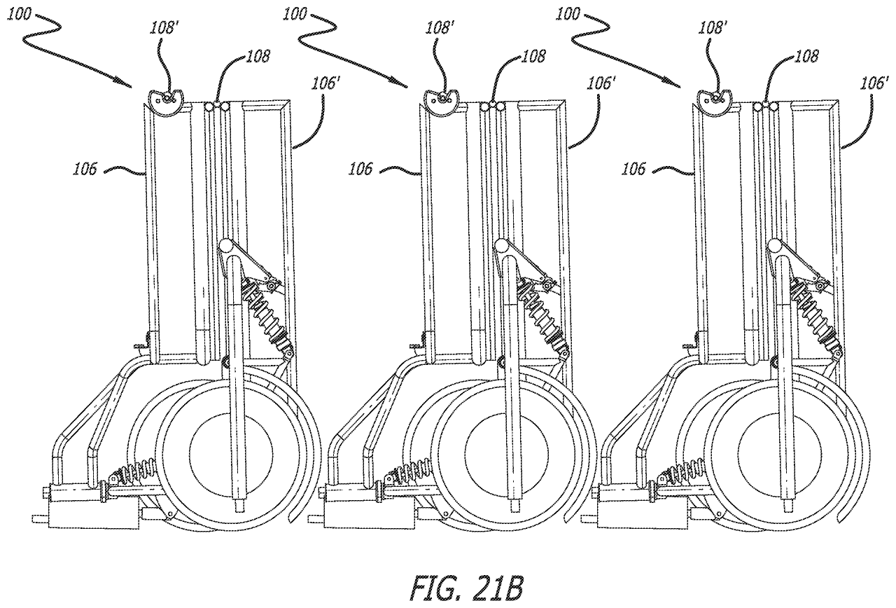

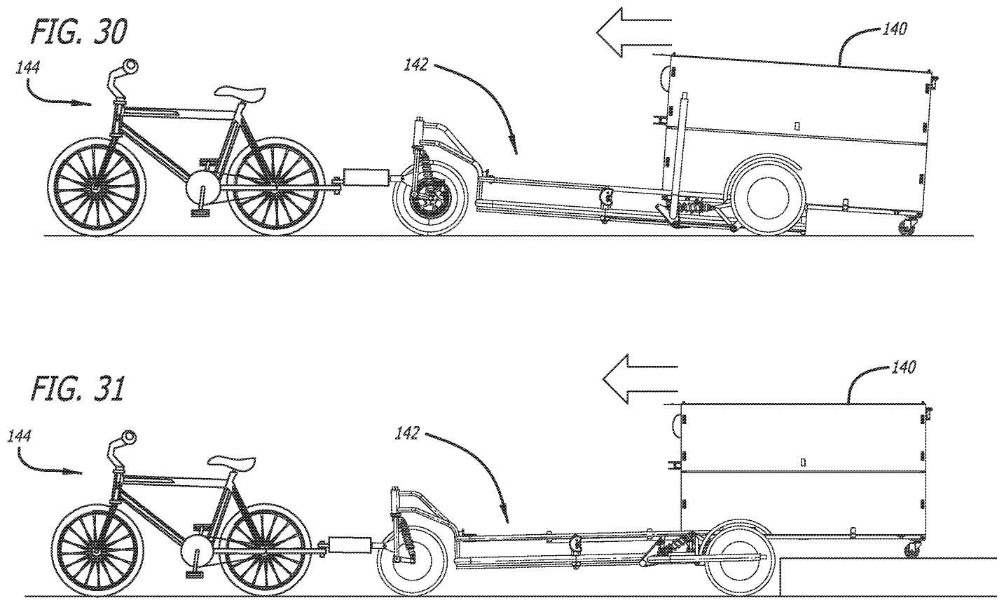

Various embodiments also incorporate compactible haulers configured and sized to support a compatible container (e.g., container cart as previously described) having at least two operational configurations. In many such embodiments the compactible hauler has a first unfolded configuration where the hauler platform is configured in a single elongated horizontal plane, and at least a second compacted configuration where the hauler platform is disposed in two adjacent longitudinal plans disposed parallel to each other and where the interior platform are folded into a configuration parallel to the planes of the sidewalls, as shown in FIGS. 21 and 30.

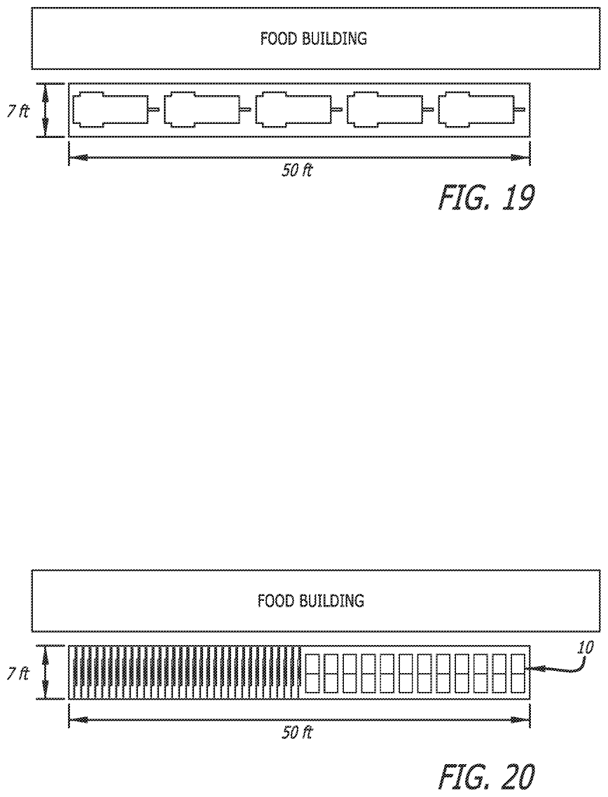

The use of such compactible haulers addresses a second issues with conventional delivery systems. Distribution centers must preposition haulers along the street for loading of containers ready for delivery, as shown in FIG. 19. However, there is only a set amount of street front on which such trailers or haulers may be positioned. Accordingly, using conventional haulers and trailers allows for only a limited number to be positioned at any one time, and also doesn't allow for efficient use of the valuable street frontage for haulers being stored for later use. Compactible haulers according to embodiments allows for significantly more efficient use of the street frontage. As shown in FIG. 20, it is possible to store a vastly larger number of compactible haulers when not in use and then only unfold then for container loading when needed.

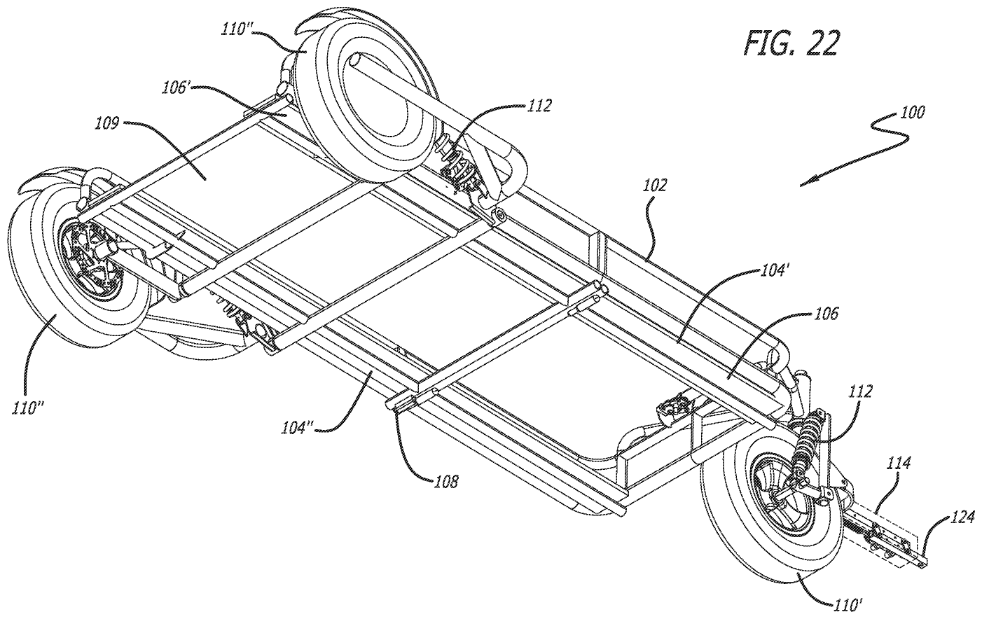

As shown in FIGS. 21A, 21B and 22, in many embodiments compactible haulers (100) include a frame structure (102) that supports a hauler platform (104), that may be a solid sheet, or as shown tracks (104′ & 104″) disposed on either inner side of the frame. For compactibility the hauler platform is divided into at least two sections (106 & 106′) interconnected by hinge joints (108) that in many embodiments may be lockable (108′) to prevent unintended pivoting of the hauler platform during use. During operation this hinge may be unlocked and the two section of the hauler platform pivoted relative to each other such that two section lie in adjacent parallel planes to each other and the front 110′ and rear wheels 110″ overlap, with the front wheel extending through the open space (109) formed between the tracks 104′ and 104″ of the hauler platform (as shown in FIG. 21B). Although the hauler presented is shown as having three wheels interconnected with the frame structure, it will be understood that any suitable arrangement of supporting wheels capable of overlapping when in a compacted configuration may be used. As shown, such wheels may be interconnected to the frame structure with resilient members (i.e., springs, etc.) (112) such that road bumps are dampened during use. The trailer may also incorporate an integrated hitch braking system (114) attached proximate to the front wheel where the trailer would interconnect with the propulsion device to prevent the trailer from impacting the propulsion device during braking, as will be described in greater detail below. Using a compactible hauler, in accordance with embodiments, it is possible to stack a large number of compacted haulers in very limited space, as shown in FIG. 21B.

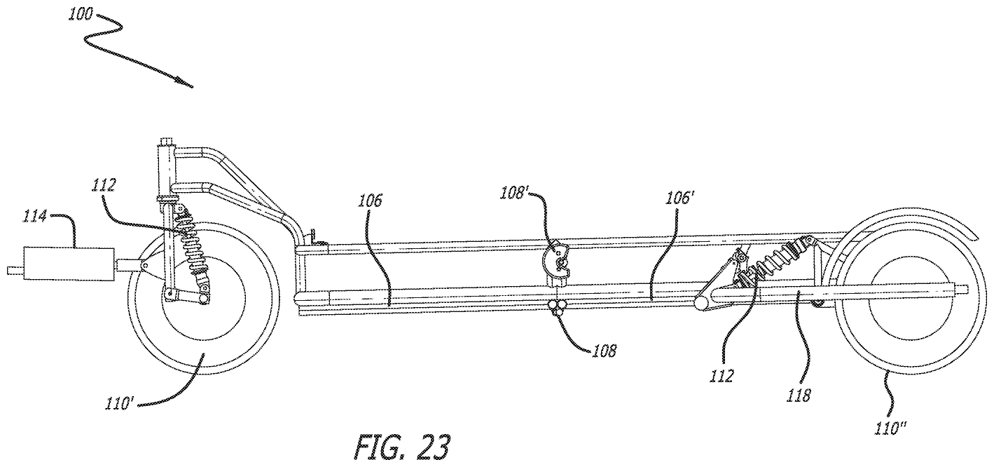

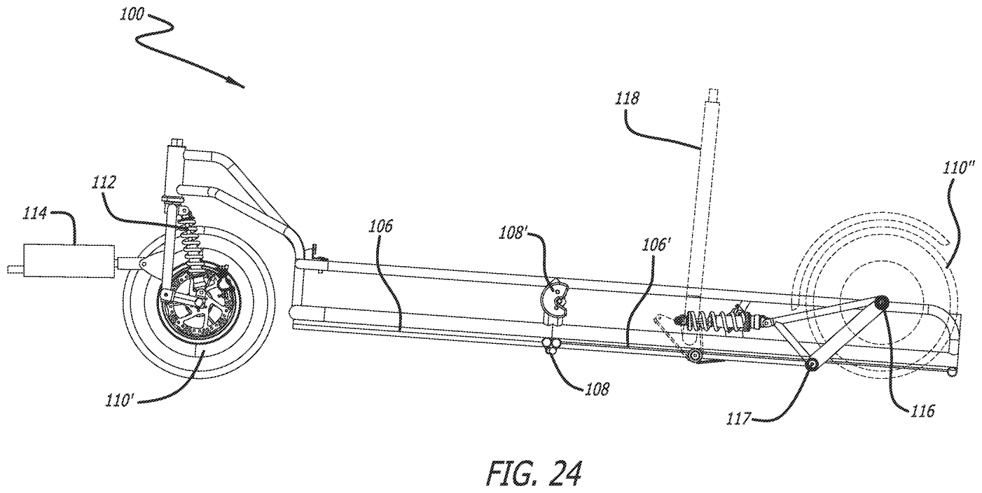

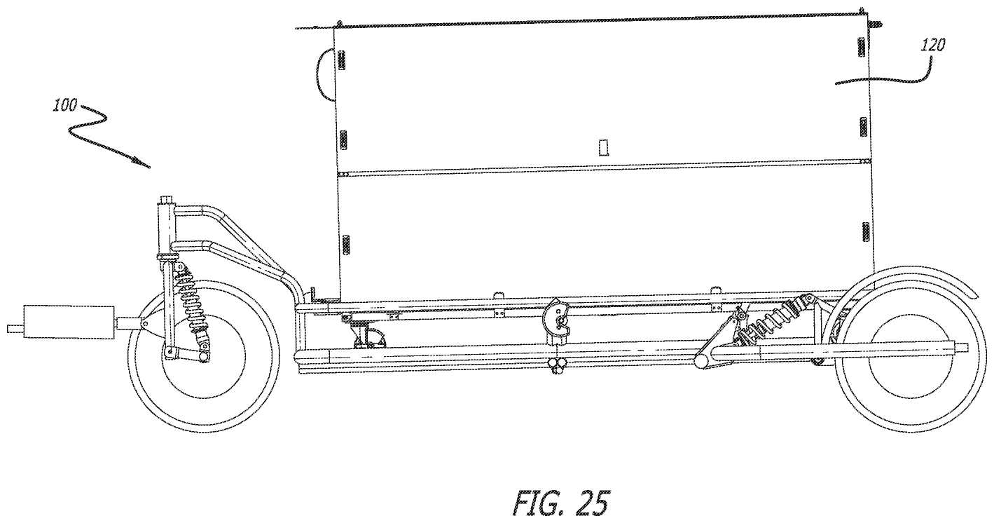

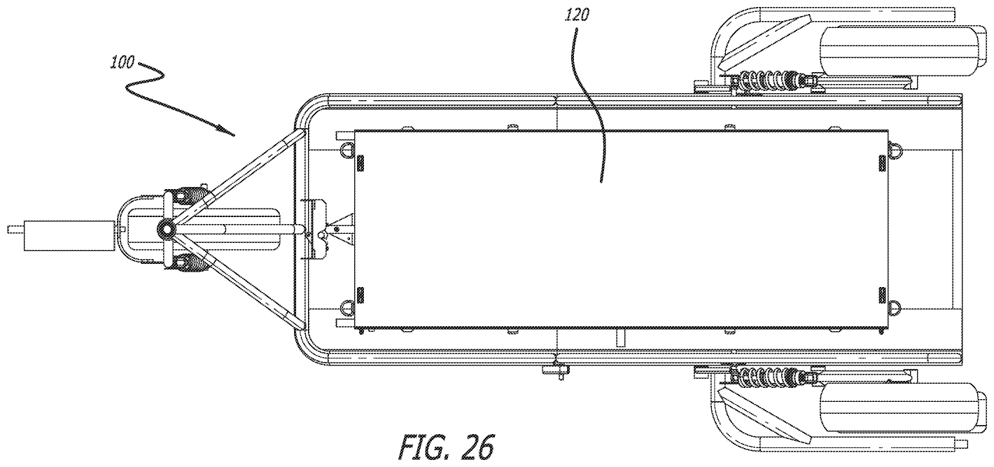

Turning to FIGS. 23 to 25, in many embodiments the compactable hauler is also configured with a mechanism to pivot the hauler platform (104) such that the portion proximate to the front wheel (110′) is disposed higher than the portion proximate the rear wheels (110″), and such that the portion proximate the rear wheels is positioned close enough to the ground to serve as a ramp structure for rolling container carts from the ground onto the hauler. In embodiments including such a ramp mechanism, the hauler further comprises a pivotably mounted rear wheel axle (116) further pivotably interconnected with the frame (117) and a suitable deployment mechanism, such as, for example, a handle (118). In various embodiments (as shown in FIGS. 23 & 24), this combination of pivoting members is conifugred such that rotation of the handle results in a linked pivoting of the axle and rear portion (106′) of the hauler platform from a first position where the pivot point (116) of the rear wheel is in-line with the horizontal plane of the portion of hauler platform (106′), as shown in FIG. 23, to a second position where the center point of the rear wheel is extended above the plane of the portion of the hauler platform (106′), a shown in FIG. 24. In some such embodiments the linkage between at least one of the pivoting members (e.g., handle and axle) are interconnected through the resilient member such that there is an inherent locking of the axle into position during operation in either the lowered or raised positions. Utilizing such a ramp mechanism it is possible to easily roll a wheeled container cart (120) in accordance with embodiments onto the compactable hauler (100) for transport, as shown in FIGS. 25 & 26).

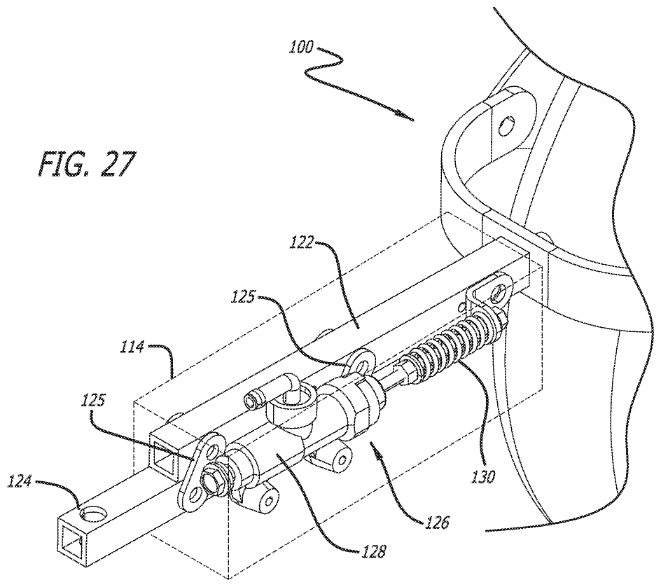

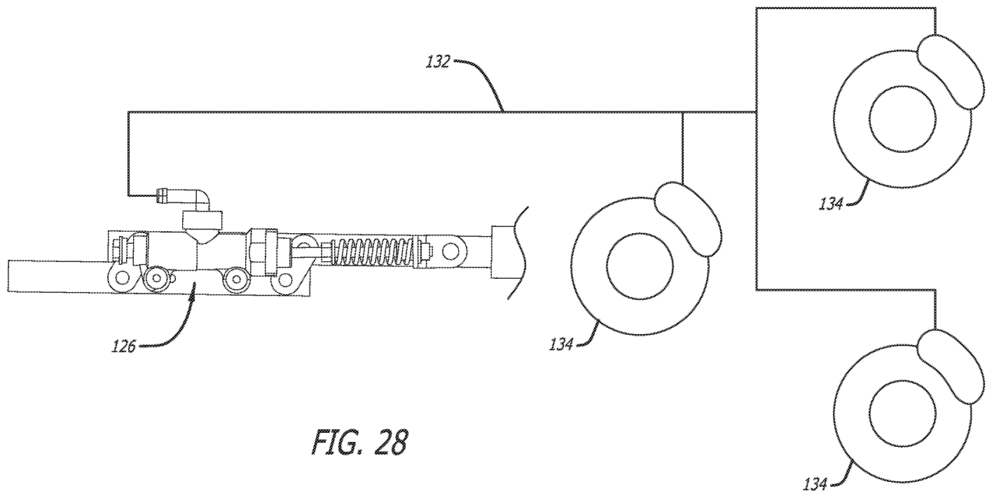

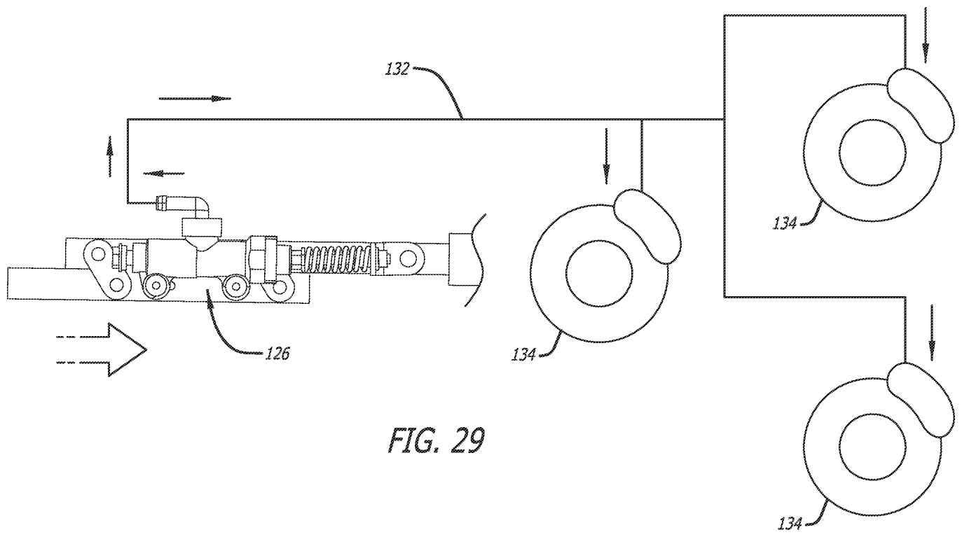

Some embodiments can include an integrated hauler braking mechanism, as shown in exemplary form in FIGS. 27 to 29. As shown, in an exemplary embodiment such a braking mechanism may include a surge braking mechanism (114) configured to be interconnected through a first support member (122) to the hauler (100) and through a second support member (124) to the propulsion device (e.g., through a conventional hitch mechanism) which are pivotably interconnected via at least one hinge (125). In many such embodiments, the surge braking mechanism comprises a pneumatic brake (126) fixedly connected to the second support member at a first end (128) (e.g., where the pneumatic cylinder is disposed) and fixedly connected to the first support member (122) at a second end (130) (e.g., where a resilient member is disposed) which is slidingly engaged into the pneumatic cylinder such that as the first and second support members move relative to each other the resilient second end (130) of the pneumatic brake (126) slides into and out of the pneumatic cylinder (128) thereby generating and relieving pressure in the relevant brake lines (132) interconnected with the wheels (134) of the hauler. Of note, many embodiments of the surge braking mechanism replace the conventional design sliding relationship between support members with a pivoting action (as shown in FIGS. 28 & 29) thereby creating a more robust braking mechanism that is much less susceptible to jamming.

The kneeling mechanism of the hauler allows for loading of the hauler in two different modes, as shown in FIGS. 30 and 31. In a first, where the hauler platform is lowered such that the hauler acts as a ramp, containers may be loaded from the ground (FIG. 30). In a second, where the hauler platform remains in a position level with the center of the wheels, the hauler may be configured such that loading straight from a curb or other raised platform can be accomplished (FIG. 31).

Although one particular embodiment of a compactible hauler is shown herein, it will be understood that other elements of delivery system embodiments may be incorporated with other haulers, including other conventional haulers and compactible haulers, such as, for example, as described in U.S. Pat. No. 10,214,230, the disclosure of which is incorporated herein by reference.

### Embodiments Implementing Propulsion Devices

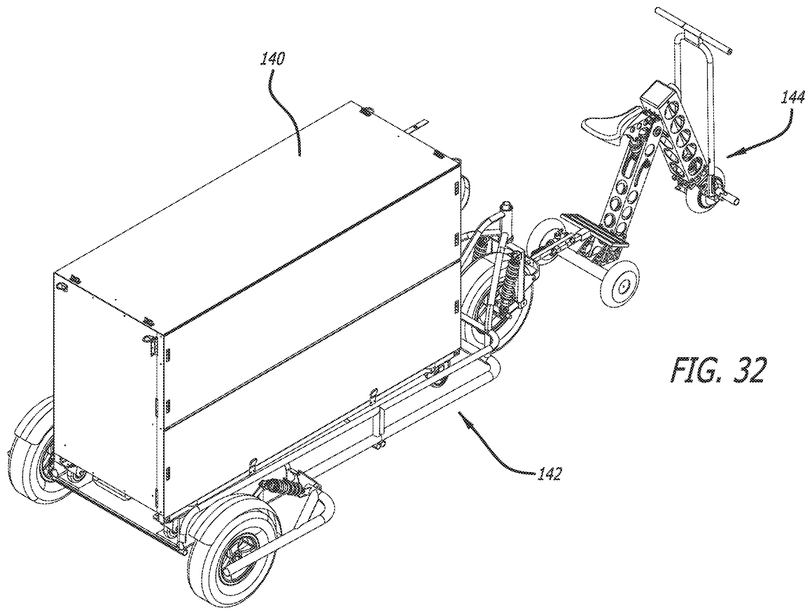

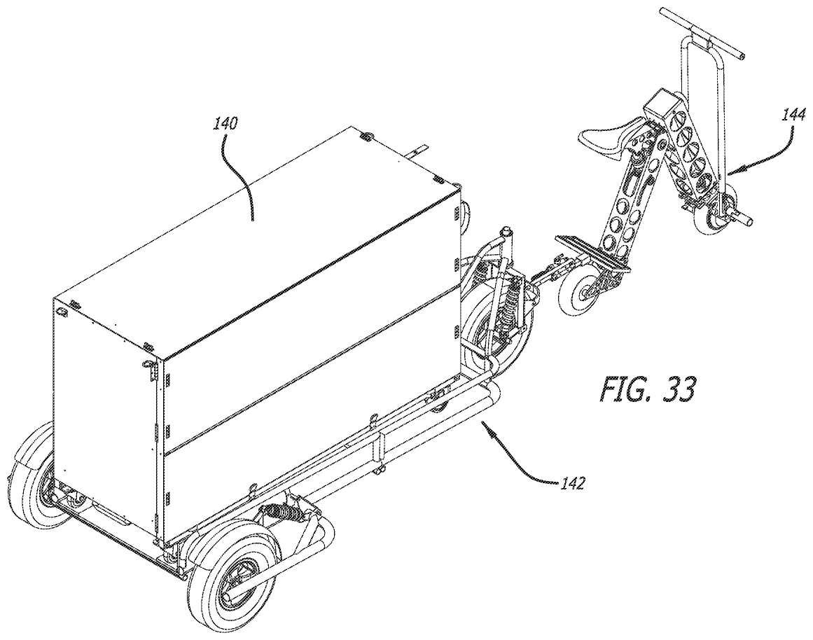

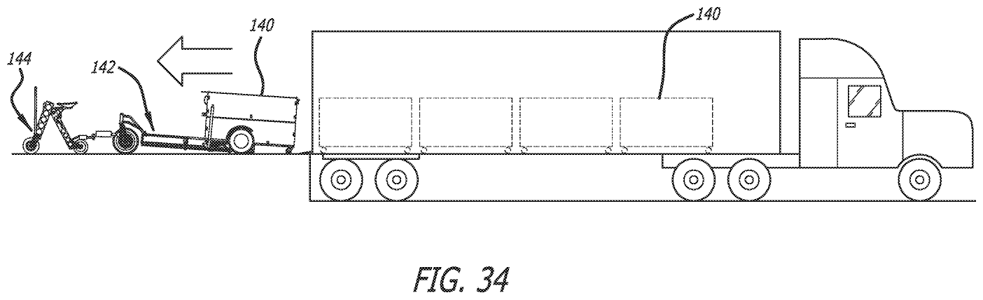

As previously described, embodiments of cart containers and haulers may be used with any suitable propulsion device including, bicycles, e-bikes, rickshaws, motorized vehicles, etc. In many embodiments, the propulsion device used in conjunction with the container (140) and hauler (142) itself may take the form of an electric scooter (144), as shown in FIGS. 32 and 33. In some such embodiments the electric scooter itself could be compactible thereby further reducing the spatial footprint of the overall delivery system. (See, e.g., U.S. Pat. Nos. 9,227,687; 9,694,868; 9,873,476; the disclosures of each of which are incorporated herein by reference.) Integrated together elements of delivery systems may be combined to provide a complete solution to delivery from truck to hauler to customer, as shown in FIG. 34.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

1. A compactible cart comprising:
a support structure comprising a pair of longitudinal sidewall elements disposed parallel to each other and a pair of latitudinal end wall elements disposed parallel to each other, wherein the sidewall and end wall elements are pivotably interconnected at each end to each other such that said sidewall and end wall elements may be rotated between a first wall position where the sidewalls and end walls are disposed orthogonal to each other forming an internal volume and a second wall position where the sidewalls and end walls are disposed parallel to each other;
at least a top platform element pivotably interconnected to one of either the sidewall or end wall elements at an upper end thereof, and a bottom platform element pivotably interconnected to one of either the sidewall or the end wall elements at a lower end thereof, such that said internal platform elements may be rotated between a first platform position where said internal platform elements are disposed parallel to the side and end walls and a second platform position where said internal platform elements are disposed perpendicular to the side and end walls; and
a plurality of wheels disposed below the bottom platform, wherein at least one wheel is disposed at each of the corners of the cart;
wherein the elements of the cart are configured such that when at least one of the top or bottom platform elements are disposed in the second platform position the sidewall and end wall elements are prevented from pivoting.

2. The compactible cart of claim 1, further comprising at least one internal platform element pivotably interconnected to one of either the sidewall or end wall elements between the upper and lower ends thereof.

3. The compactible cart of claim 2, wherein each of at least the internal and bottom platform elements are formed of two platform elements each pivotably interconnected to opposing sidewall or end wall elements.

4. The compactible cart of claim 1, wherein each of the sidewalls and end walls are open such that the internal volume is open.

5. The compactible cart of claim 1, wherein each of the sidewalls and end walls are solid to enclose the internal volume.

6. The compactible cart of claim 5, wherein the at least one of longitudinal sidewall element is pivotably connected to an upper portion of the support structure such that the sidewall may be rotated relative to the support structure providing access to the internal volume.

7. The compactible cart of claim 6, wherein the at least one pivotably connect longitudinal sidewall element is formed of two pivotably interconnected longitudinal sidewall portions.

8. The compactible cart of claim 6, further comprising at least one latch configured to secure the at least one pivotably connected longitudinal sidewall element from rotation relative to the support structure.

9. The compactible cart of claim 6, wherein the top platform and pivotably connected longitudinal sidewall are hinged together such that only one may be rotated relative to the support structure at a time.

10. The compactible cart of claim 1, further comprising at least one latch configured to secure the top platform from rotation relative to the support structure.

11. A compactible hauler comprising:
a frame supporting a platform, wherein said frame and platform are formed of at least front and rear portions pivotably interconnected along a longitudinal axis thereof such that said at least two portions may be rotated between a first position where the portions are disposed in-line with each other and a second position where the portions are disposed in adjacent parallel planes; and
at least two sets of wheels, wherein at least one set of wheels is disposed on a front portion and wherein at least one set of wheels is disposed on a rear portion, and wherein when the portions are disposed in the second position the sets of wheels overlap;
wherein the rear wheels are pivotable relative to the frame and platform such that in a first position the rear and portions are disposed at the same height, and wherein in a second position the rear portion is dispose at a height lower than the front portion.

13. The compactible hauler of claim 11, wherein a single wheel is disposed on the front portion and a set of two wheels are disposed on the rear portion.

14. The compactible hauler of claim 13, wherein the platform further comprises a center open section configured such that the single wheel on the front portion passes at least partially therethrough when disposed in the second position.

15. The compactible hauler of claim 11, further comprising a surge braking mechanism disposed on the front portion.

16. The compactible hauler of claim 15, wherein the surge braking mechanism comprises:
at least a first brake support member interconnected with the hauler frame;
at least a second brake support member pivotably interconnected with the first brake support member and configured to be interconnected with a propulsion device at an end distal to the second brake support member;
a pneumatic brake element having a pneumatic cylinder fixedly interconnected to the second brake support member, and a rod having a resilient member disposed thereon, the rod slidingly engaged within the pneumatic cylinder at a first end and fixedly interconnected to the first brake support member;
wherein when the first brake support member is pivoted in the direction of the second brake support member the rod is pushed into the pneumatic cylinder applying the braking mechanism.

17. A delivery system comprising:
a compactible hauler comprising:
a frame supporting a platform, wherein said frame and platform are formed of at least front and rear portions pivotably interconnected along a longitudinal axis thereof such that said at least two portions may be rotated between a first position where the portions are disposed in-line with each other and a second position where the portions are disposed in adjacent parallel planes, and
at least two sets of wheels, wherein at least one set of wheels is disposed on a front portion and wherein at least one set of wheels is disposed on a rear portion, and wherein when the portions are disposed in the second position the sets of wheels overlap,
wherein the rear wheels are pivotable relative to the frame and platform such that in a first position the rear and portions are disposed at the same height, and wherein in a second position the rear portion is dispose at a height lower than the front portion; and
wherein the platform is configured to support a compactible cart comprising:
a support structure comprising a pair of longitudinal sidewall elements disposed parallel to each other and a pair of latitudinal end wall elements disposed parallel to each other, wherein the sidewall and end wall elements are pivotably interconnected at each end to each other such that said sidewall and end wall elements may be rotated between a first wall position where the sidewalls and end walls are disposed orthogonal to each other forming an internal volume and a second wall position where the sidewalls and end walls are disposed parallel to each other,
at least a top platform element pivotably interconnected to one of either the sidewall or end wall elements at an upper end thereof, and a bottom platform element pivotably interconnected to one of either the sidewall or the end wall elements at a lower end thereof, such that said internal platform elements may be rotated between a first platform position where said internal platform elements are disposed parallel to the side and end walls and a second platform position where said internal platform elements are disposed perpendicular to the side and end walls, and
a plurality of wheels disposed below the bottom platform, wherein at least one wheel is disposed at each of the corners of the cart,
wherein the elements of the cart are configured such that when at least one of the top or bottom platform elements are disposed in the second platform position the sidewall and end wall elements are prevented from pivoting.

18. The delivery system of claim 17, further comprising a propulsion device interconnectable with the compactible hauler.

19. The delivery system of claim 18, wherein the propulsion device is a compactible electric scooter.

20. A method of delivering packages comprising:
delivering goods to a distribution center;
organizing said goods onto one or more compactible carts comprising:
a support structure comprising a pair of longitudinal sidewall elements disposed parallel to each other and a pair of latitudinal end wall elements disposed parallel to each other, wherein the sidewall and end wall elements are pivotably interconnected at each end to each other such that said sidewall and end wall elements may be rotated between a first wall position where the sidewalls and end walls are disposed orthogonal to each other forming an internal volume and a second wall position where the sidewalls and end walls are disposed parallel to each other,
at least a top platform element pivotably interconnected to one of either the sidewall or end wall elements at an upper end thereof, and a bottom platform element pivotably interconnected to one of either the sidewall or the end wall elements at a lower end thereof, such that said internal platform elements may be rotated between a first platform position where said internal platform elements are disposed parallel to the side and end walls and a second platform position where said internal platform elements are disposed perpendicular to the side and end walls, and
a plurality of wheels disposed below the bottom platform, wherein at least one wheel is disposed at each of the corners of the cart,
wherein the elements of the cart are configured such that when at least one of the top or bottom platform elements are disposed in the second platform position the sidewall and end wall elements are prevented from pivoting;
loading said compactible carts onto one or more compactible haulers comprising:
a frame supporting a platform, wherein said frame and platform are formed of at least front and rear portions pivotably interconnected along a longitudinal axis thereof such that said at least two portions may be rotated between a first position where the portions are disposed in-line with each other and a second position where the portions are disposed in adjacent parallel planes, and
at least two sets of wheels, wherein at least one set of wheels is disposed on a front portion and wherein at least one set of wheels is disposed on a rear portion, and wherein when the portions are disposed in the second position the sets of wheels overlap,
wherein the rear wheels are pivotable relative to the frame and platform such that in a first position the rear and portions are disposed at the same height, and wherein in a second position the rear portion is dispose at a height lower than the front portion; and
interconnecting each compactible hauler with a propulsion system to deliver said goods.
